(19) United States
(12) Patent Application Publication
(10) Pub. No.: US 2011/0049874 A1
(43) Pub. Date: Mar. 3, 2011

(54) Polymeric pipe fitting and gasket assembly and sealed polymeric pipe apparatus formed therewith

(75) Inventors: Julie Starnes Parker, Waxhaw, NC (US); Nicholas George Peth, Monroe, NC (US)

(73) Assignee: Charlotte Pipe and Foundry Company, Charlotte, NC (US)

(21) Appl. No.: 12/583,805

(22) Filed: Aug. 26, 2009

(51) Int. Cl. F16L 19/00; F16L 55/00

(52) U.S. Cl. 285/337; 285/347

(57) ABSTRACT

A polymeric pipe fitting assembly for joinder with a polymeric pipe section without using adhesives or other chemicals comprises a polymeric fitting and an elastomeric gasket formed as a unit, preferably by molding. The fitting has a main body portion with a pipe-receiving socket portion at one end. The gasket has a first axial portion molded in intimate sealed surface engagement interiorly within the socket portion and a second integral axial portion projecting axially from the socket portion. The axial portions of the gasket form a continuous interior wall surface for receiving a polymeric pipe section in peripheral surface contact with an exterior surface of the pipe section. The second axial portion of the gasket is encircled by a mechanical clamping device for sealing the gasket against the exterior of the pipe section.

### BACKGROUND OF THE INVENTION

The present invention relates generally to polymeric plastic pipes and fittings and means and methods for sealed joinder thereof and, more particularly, to structures and systems for joining plastic pipes and fittings via an elastomeric gasket therebetween.

Polymeric plastic pipes and fittings find applications in numerous and diverse environments and uses, ranging from plumbing installations wherein the pipes and fittings serve as conduits for fresh potable water, wastewater/sewage, chemicals and/or other liquids or fluids, to electrical installations in which the pipes and fittings serve to enclose and direct electrical wiring, cables and the like. In substantially all such installations, it is desirable if not necessary that a sealed joinder be provided between connecting pipes and fittings to prevent leakage of materials from the piping system and/or to prevent infiltration of contaminants from outside the piping system.

Such plastic pipes and fittings offer cost, production and other advantages over cast iron, copper and other metals, but a disadvantage is that most plastic pipes and fittings present environmental concerns, particularly resulting from the requirement that hazardous adhesive compounds must typically be used to bond pipes and fittings together in a sealed manner. Governmental and other regulations are becoming increasingly strict in imposing limitations and controls over the formulation of plastic pipe and fitting compounds and the use of plastic pipe bonding adhesives.

Accordingly, while adhesive bonding of plastic pipe and fittings remains the currently most reliable means of sealed joinder between these components in the present state of the art, there is a growing recognized need and desire within the relevant industry for alternative devices and methods of sealing plastic pipes and fittings together, without the use of environmentally hazardous chemicals.

### SUMMARY OF THE INVENTION

Briefly summarized, the present invention seeks to address the foregoing need in the industry by providing a novel tubular polymeric pipe fitting assembly which is adapted for sealed joinder with a tubular polymeric pipe section without the use of adhesives or other bonding chemicals. According to one aspect of the invention, the present pipe fitting assembly comprises a polymeric fitting and an elastomeric gasket assembled as a unit, preferably by integrally molding these elements together.

In the present pipe fitting assembly, the fitting basically has a tubular main body portion and an annular pipe-receiving socket portion at one end of the main body portion collectively defining interiorly therethrough a passageway. The elastomeric gasket has a first tubular axial portion in intimate sealed annular surface engagement with an interior annular wall surface of the socket portion and a second tubular axial portion integral with the first axial portion and projecting axially outwardly from the socket portion. The first and second axial portions of the gasket collectively form a continuous interior annular wall surface adapted for receiving a tubular polymeric pipe section in peripheral annular surface contact with an exterior annular surface of the pipe section. The second axial portion of the gasket is adapted to be exteriorly encircled by a clamping device for exerting a mechanical force for sealing the second axial portion of the gasket against the exterior annular surface of the pipe section.

Thus, a further aspect of the present invention is the provision of a sealed tubular polymeric pipe apparatus comprising the polymeric fitting and elastomeric gasket assembly, with a tubular polymeric pipe section received interiorly within the gasket with the interior annular wall surface of the gasket in peripheral annular surface contact with an exterior annular surface of the pipe section and with the clamping device exteriorly encircling the second axial portion of the gasket for exerting a mechanical force sealing the second axial portion of the gasket against the exterior annular surface of the pipe section.

According to one preferred feature of the invention, the first axial portion of the gasket is molded in intimate sealed annular surface engagement with the interior annular wall surface of the socket portion. It is further preferred that a mechanical interconnection is also provided between the first axial portion of the gasket and the socket portion of the fitting. For example, one form of the mechanical interconnection may comprise a surface depression formed into the interior annular wall surface of the socket portion into which the first axial portion of the gasket is molded. In a more specific such example, the surface depression may comprise a radial opening formed into the interior annular wall surface of the socket portion and a stub portion protruding from the first axial portion of the gasket into the radial opening.

Various forms of clamping devices may be utilized in the present invention. For example, one type of clamp that may be advantageously used in the present invention is a band-type clamp, such as commonly equipped with a worm gear-actuated means for tightening and loosening the clamp. An alternative form of clamping device may comprise an annular collar attachable to the socket portion of the fitting in compressive engagement annularly with the second axial portion of the gasket. For example, the socket portion of the fitting may have a spiral thread formed in an exterior annular wall surface of the socket portion and the annular collar may have a mating spiral thread for rotational threaded engagement between the socket portion of the fitting and the collar. In such a clamping device, the collar and the second axial portion of the gasket may be compatibly configured for axial and radial compression of the second axial portion of the gasket by the collar, e.g., via mating tapered surfaces disposed for engagement with one another.

The fitting may be formed of various polymeric materials, e.g., polypropylenes, polyethylenes, acrylonitrile-butadiene-styrenes, other styrenes, and chlorinated polyvinyl chlorides, and other polyvinyl chlorides. A random copolymer of an impact grade of polypropylene is presently contemplated to be preferred. Also, it is contemplated that the fitting may be made of a multi-layer construction, e.g. with outer and inner layers of a solid polymeric material between which is contained a polymeric foam layer, which could achieve weight reduction and attendant reduction in cost. Various filler materials, e.g., calcium carbonate, magnesium hydroxide, ammonium octamolybdate, alumina trihydrate, and barium sulfate, could be included as additives to the polymeric material for the fitting to impart enhanced properties such as flame resistance, flame retardancy, smoke suppression, added density, sound deadening, impact resistance, added stiffness, and/or other properties. Likewise, the gasket may be formed of various elastomers, e.g., thermoplastic vulcanizates, flexible polyvinyl chlorides, thermoplastic olefins, thermoplastic elastomers, synthetic rubbers, and natural rubbers. In one contemplated embodiment, the gasket may be formed of a first elastomer for promoting adhesion between the first axial portion of the gasket and the interior annular wall surface of the socket portion and a second elastomer for promoting sealing contact between the gasket and the exterior annular surface of the pipe section.

In one possible embodiment of the invention, the fitting may include a socket configured as an enlarged bell-shaped hub-like tubular socket, wherein the passageway through the tubular main body portion of the fitting is of a nominal internal cross-sectional dimension while the passageway through the annular socket portion is of an internal cross-sectional dimension greater than the nominal internal cross-sectional dimension of the passageway. In other embodiments, the fitting may include a main body and a socket formed in cylindrical coaxial alignment with one another, i.e., without an enlargement of the socket relative to the main body.

According to another feature of the present invention, the fitting may further include a retaining element projecting interiorly within the fitting radially inwardly into the passageway to engage the outer circumferential surface of the inserted end of a straight pipe section, thereby providing a supplementary means of mechanical engagement with the pipe section assisting the clamping device.

These and other aspects, features and advantages of the present invention will become more apparent from the following disclosure and the accompanying drawings.

### BRIEF DESCRIPTION OF THE DRAWINGS

FIG. 1 is a front perspective view of a pipe apparatus in accordance with one contemplated embodiment of the present invention;

FIG. 2 is a rear perspective view of the pipe apparatus of FIG. 1;

FIG. 3 is a lengthwise cross-sectional view of the pipe apparatus of FIG. 1, taken along the line 3-3 thereof;

FIG. 4 is an enlargement in cross-section of the area 4 of the pipe apparatus of FIG. 3;

FIG. 5 in another enlarged cross-section, similar to FIG. 4, showing an alternative embodiment of the pipe apparatus;

FIG. 6 is a side elevational view of a pipe apparatus in accordance with another contemplated embodiment of the present invention; and

FIG. 7 is a lengthwise cross-sectional view of the pipe apparatus of FIG. 6, taken along line 6-6 thereof.

### DETAILED DESCRIPTION OF THE PREFERRED EMBODIMENTS

Referring now to the accompanying drawings and initially to FIGS. 1 and 2, a tubular pipe apparatus according to one embodiment of the present invention is indicated generally at 10 and basically comprises a tubular fitting assembly 12 joining and forming a sealed connection with two tubular straight pipe sections 14, 16 via clamping devices 18 retaining the elements of the pipe apparatus 10 securely together. The pipe apparatus 10 of the present invention is characterized by the absence of any required adhesive, chemical, or other potentially hazardous bonding agent or composition for sealing the fitting assembly 12 and the pipe sections 14, 16 to one another.

The pipe apparatus 10 and fitting assembly 12 of the present invention are particularly adapted and intended for use in joining pipe sections made of polymeric materials, commonly referred to in the trade collectively and generically as plastic pipe. Such plastic pipes are well-known and in common use. The pipe sections 14, 16 shown in the accompanying drawings and as described herein may be of any such known construction and/or configuration. Thus, as illustrated in the drawings and as described herein, the pipe sections 14, 16 are depicted merely as common representative cylindrical straight pipe sections, each of a uniform annular wall thickness defined between inner and outer cylindrical wall surfaces, and defining through the length of each pipe section an open passageway. However, those persons skilled in the art will also recognize that the pipe apparatus 10 and fitting assembly 12 of the present invention are equally well adapted for use with other plastic pipes, e.g., of a novel or specialized polymeric composition or physical structure or construction, whether currently known or yet to be developed. Accordingly, the present invention is not intended and should not be construed to exclude the use and application of the present invention in other embodiments with other plastic pipes.

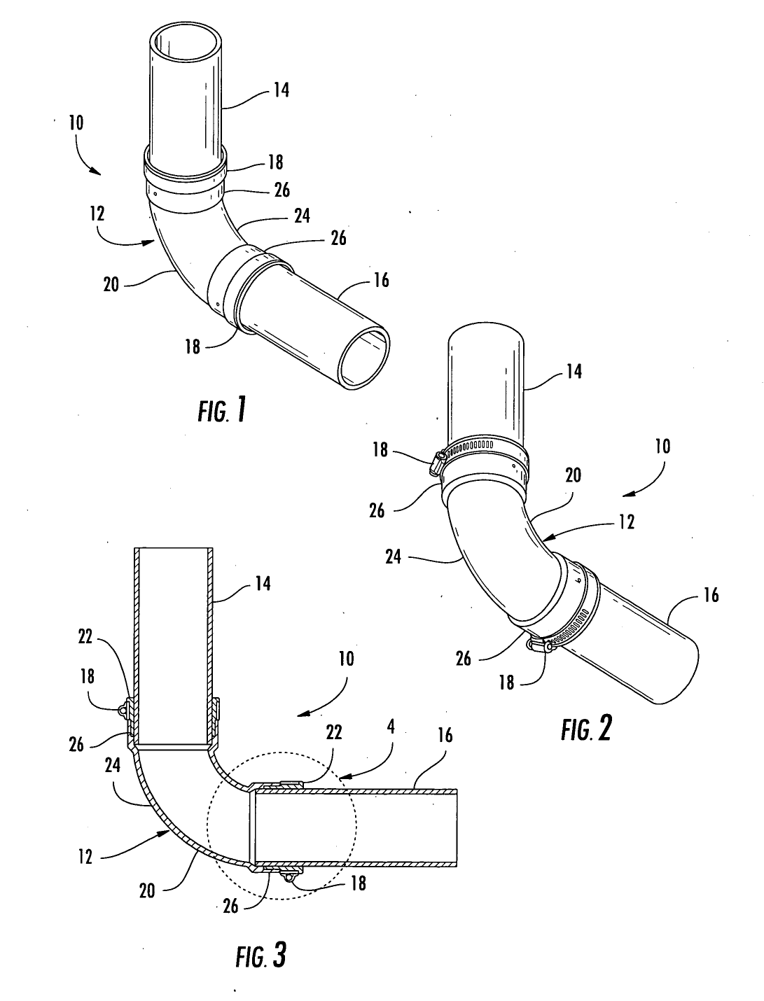

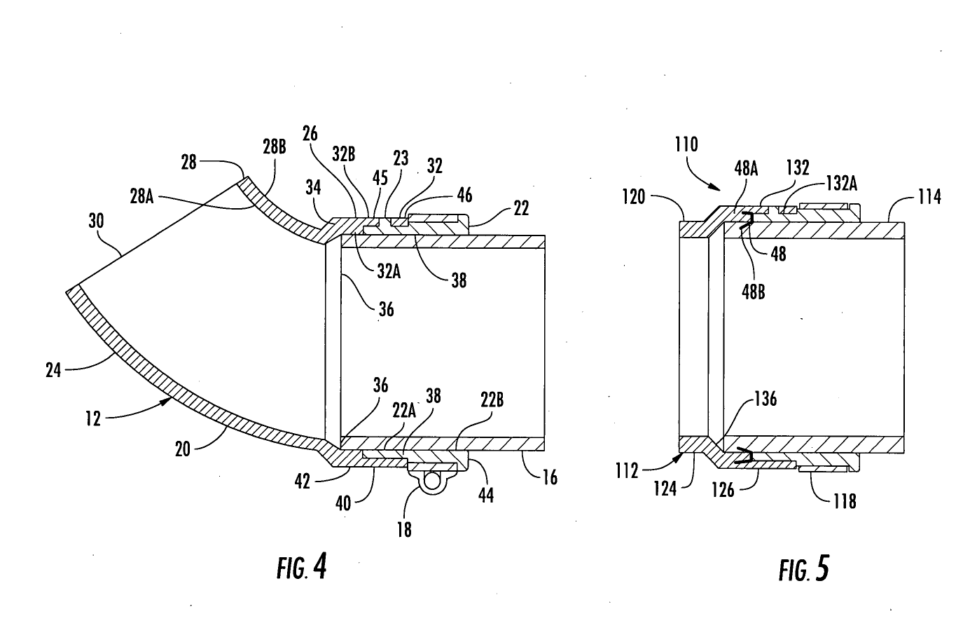

With additional reference to FIGS. 3 and 4, the fitting assembly 12 basically comprises a tubular fitting 20 equipped at its opposite ends with integral gaskets 22. The fitting 20 in this representative embodiment is of an elbow-type pipe fitting construction having a tubular main body 24 extending in an elongated arc of substantially ninety degrees (90°) with enlarged bell-shaped hub-like tubular sockets 26 integrally formed with the main body 24 at its opposite ends. The tubular main body 24 is formed by a continuous annular wall 28 of an essentially uniform wall thickness between inner and outer annular wall surfaces 28A, 28B, and preferably is of a substantially circular cross-section defining an open interior passageway 30 of an essentially uniform nominal cross-sectional dimension diametrically transverse to the interior surface 28A through the length of the main body 24. Each socket 26 has an annular stub wall 32 also of an essentially uniform wall thickness between inner and outer annular stub wall surfaces 32A, 32B, and preferably is similarly of a substantially circular transverse diametric cross-section but of a larger cross-sectional diametric dimension than the nominal cross-section of the main body 24. The stub wall 32 of each socket 26 is joined coaxially to one respective end of the annular wall 28 via an angled annular connecting bridge wall section 34, thereby forming an undercut shoulder 36 interiorly of the fitting 20 surrounding and radially outward of the adjacent end of the annular interior wall surface 28A.

Each gasket 22 is in the form of a generally cylindrical annular sleeve preferably made of a compressibly resilient elastomeric material. More specifically, each gasket 22 is of an axial length greater than that of the interior wall surface 32A of the respective stub wall 32. Each gasket 22 has a cylindrical interior wall surface 38 of a circular cross-sectional diametric dimension substantially uniform along the full length of the gasket 22, matched to or slightly smaller than the outer cross-sectional dimension of the respectively associated straight pipe section 14 or 16. The cylindrical exterior wall surface 40 of each gasket 22 comprises a first axial portion 42 whose axial extent essentially corresponds to the axial length of the associated interior stub wall surface 32A and whose outer cross-sectional diametric dimension matches that of the inner cross-sectional diametric dimension of such associated interior stub wall surface 32A. The cylindrical exterior wall surface 40 of each gasket 22 further comprises a second axial portion 44 of an axial extent projecting axially outwardly beyond the terminal axial end edge of the associated stub wall 32 and having an outer cross-sectional diametric dimension greater than that of the first axial portion 42 forming a radial shoulder 46 therebetween. Each gasket 22 is integrally secured sealably within the stub wall 32 of the associated socket 26, with the first axial gasket portion 42 in sealed intimate continuous annular surface engagement with the interior stub wall surface 32A along and about the full axial and circumferential extent thereof and with the radial shoulder 46 therebetween abutted against the axial end face of the stub wall 32.

In accordance with the present invention, the fitting 20 in any given embodiment will typically be made of a polymeric material compatible with, and often corresponding to, the polymeric material of the plastic pipes with which the fitting 20 is intended to be used. Those persons skilled in the art will recognize and understand that an extensive and diverse range of polymeric compositions and formulations are available from which the fitting 20 may be fabricated. The selection of the polymeric material will, in many if not most cases, be determined in relation to the intended end use of the pipe apparatus, e.g., according to whether the pipe apparatus may be intended for a plumbing application handling water or water-borne liquids, chemical materials, gases or other fluids, whether the pipe apparatus may be intended for underground or aboveground installations, etc. It is contemplated that the present invention may be applicable to any such embodiments and uses and it is not intended nor to be construed that the present invention is limited to fittings made of any particular polymeric material. For sake of representative illustration, but without limitation, it is contemplated that the fittings of the present invention may be made of polypropylenes, polyethylenes, acrylonitrile-butadiene-styrenes (commonly known as ABS), other styrenes, chlorinate polyvinyl chlorides, and/or other polyvinyl chlorides. A random copolymer of an impact grade of polypropylene is presently contemplated to be preferred. Also, it is contemplated that the fitting may be made of a multi-layer construction, e.g. with outer and inner layers of a solid polymeric material between which is contained a polymeric foam layer, which could achieve weight reduction and enhanced impact resistance and stiffness. Various filler materials, e.g., calcium carbonate, magnesium hydroxide, ammonium octamolybdate, alumina trihydrate, and barium sulfate, could be included as additives to the polymeric material for the fitting to impart enhanced properties such as flame resistance, flame retardancy, smoke suppression, added density, sound deadening, impact resistance, added stiffness, and/or other properties. Preferably, the fitting 20 of the present invention will be produced by an injection molding or another form of molding process and, accordingly, polymeric materials for the present fitting will typically be selected to be suitable for use in such molding operations.

As noted above, the gaskets 22 are made preferably of an elastomeric material providing resilient compressibility for conformance and sealing to the surfaces of the stub walls 32 of the fitting 20 and to the peripheral surfaces of the straight pipe sections 14, 16. In embodiments wherein the fitting 20 will be injection molded, it is contemplated to be preferable that the elastomeric material for the gaskets 22 also be selected from appropriate materials suitable for injection molding. In this manner, the fitting 20 and the gaskets 22 could be fabricated in a common molding apparatus via a multi-step molding process known and commonly referred to in the injection molding art as a multi-shot injection process. Persons skilled in the art will recognize and understand that differing mold inserts or other mold elements of differing configurations would typically be required for the separate steps of first molding the fitting 20 and then molding the gaskets 22 into the fitting 20, but the design of such mold elements is within the ordinary skill of persons knowledgeable and experienced in the injection molding art and therefore need not be described in detail herein. Advantageously, such a multi-shot injection process is effective to form the gaskets 22 in intimate continuous sealed surface engagement with the interior wall surfaces 32A of the stub walls 32 of the sockets 26 to provide optimal securement and sealing therebetween. Alternative, it is contemplated and is to be understood that the gasket 22 may be joined sealably to the fitting 20 by other means, e.g., gas plate welding, hot plate joining, adhesive bonding, ultrasonic joining, or laser welding, whereby the present invention is not limited to any particular manner of joinder between the fitting and the gaskets. For sake of representative illustration, but without limitation, it is contemplated that the gaskets used in the present fitting assembly could be made from thermoplastic vulcanizates, flexible polyvinyl chlorides, thermoplastic olefins, thermoplastic elastomers, synthetic rubbers, and/or natural rubbers. These and similar elastomeric materials are known to be suitable for injection molding.

It is preferred that the molded surface interconnection of the gaskets 22 within the fitting 20 be supplemented by a mechanical interconnection between the first axial portion 42 of each gasket 22 and the socket portions 26 of the fitting 20. For example, the interior wall surface 32A of each stub wall 32 may be formed with one or more depressions, such as teeth, ridges, ribs, threads, perforations, holes or any other manner of surfacing configuration or texture to the wall surface 32A forming one or more depressions therein into which the polymeric material of the first axial portion 42 of the gasket 22 will flow during molding. In one advantageous embodiment, a radial opening 45 may be formed through the stub wall 32 of the socket 26 thereby to serve as an injection point through which the molding material for the gasket 22 may be introduced into the fitting 20 after it has first been molded. The gasket material, when cured, thereby forms a stub portion 23 protruding from the first axial portion 42 of the gasket 22 into the radial opening 45, to provide the desired mechanical connection of the gasket 22 to the fitting 20.

It is also contemplated that the injection of the gasket material can be carried out in two steps via a multi-shot molding process using two different polymeric materials, a first elastomer injected in a first molding “shot” forming a radially outwardmost gasket layer in direct surface contact with the interior wall surface 32A of the stub wall 32 and a second elastomer injected in a second molding “shot” forming a radially inwardmost gasket layer. The first elastomer would be selected to be of a composition optimally suitable for promoting bonding adhesion between the first axial portion 42 of the gasket 22 and the stub wall surface 32A of the stub wall 32 of each socket 26. The second elastomer would in turn be selected to be of a composition optimally suitable for promoting sealing contact between the interior wall surface 38 of the gasket 22 and the exterior annular surface of the pipe section 14 or 16. The interior wall surface 38 of the gasket 22 may be formed with one or more annular ribs, teeth, ridges or other protrusions to provide enhanced frictional engagement against a pipe section inserted into the gasket (as described below) and for added resistance against withdrawal of the pipe section from the gasket.

The clamping devices 18 in the illustrated embodiment of FIGS. 1-4 are common band-type clamps having an elongate toothed metal band with a screw-actuated worm gear device secured to one end which also receives the other end of the band, thereby to form the band into a ring-like annular configuration and to enable the band to be tightened into a progressively decreasing circumference by the screw actuation of the worm gear device. Such clamping devices 18 offer the advantage of ready availability, inexpensive cost and reliable operation. However, the present invention is not limited to the use of such band clamps. Rather, it is contemplated that any other form of annular clamping device could be equally well employed in the present invention, as for example is represented in the embodiment of FIGS. 6 and 7 described hereinafter.

As best seen in FIGS. 3 and 4, each plastic pipe section 14, 16 has one end inserted fully into a respective one of the sockets 26 of the fitting 20 until the inserted end of the pipe abuts the interior undercut shoulder 36 within the respective socket 26. The interior wall surface 38 of each gasket 22 fully encircles the respective pipe section 14, 16, in substantially continuous annular sealing surface engagement with the outer circumferential wall surface of the pipe. The clamping devices 18 encircle the outwardly projecting second axial portion 44 of each gasket 22 and are tightened into continuous circumferential clamping engagement thereabout, exerting a mechanical force against the axial portion 44 and, in turn, against the outer wall surface of the pipe. In this manner, the clamping devices 18 supplement and secure the sealing contact between each gasket 22 and the respective pipe sections 14, 16 and also serve to retain each pipe section 14, 16 against withdrawal from the respective sockets 26.

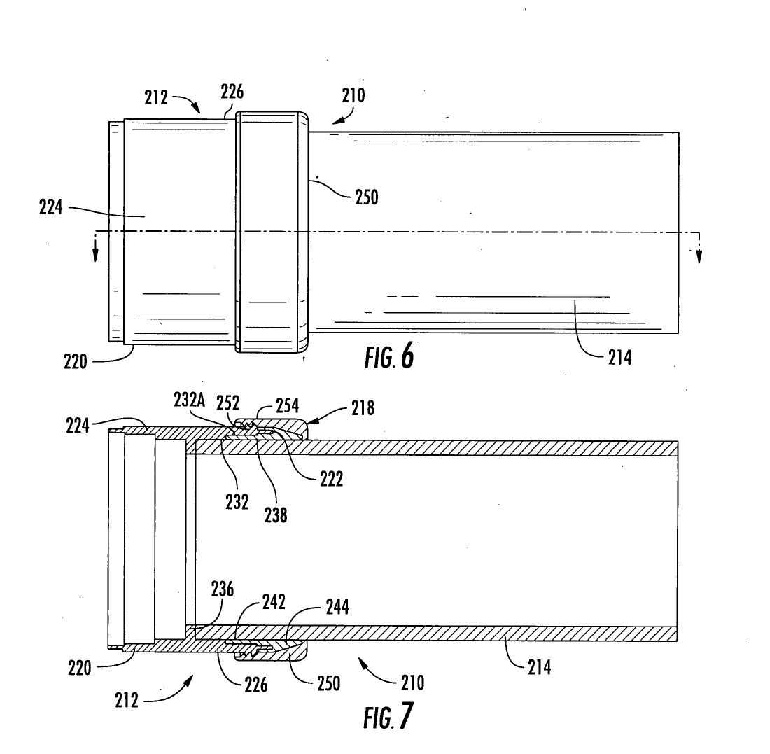

An alternative embodiment of the present pipe apparatus is indicated generally at 110 in FIG. 5, wherein elements of the pipe apparatus corresponding to the elements of the apparatus of FIGS. 1-4 are identified by corresponding reference numerals in the 100 series. The pipe apparatus 110 basically comprises a tubular fitting assembly 112 which is substantially similar in structure and application as the fitting assembly 12 of FIGS. 1-4, except that the fitting assembly 112 additionally includes an annular retaining element 48 interiorly within the stub wall 132 between the undercut shoulder 136 and the gasket 122. The retaining element 48 may be fabricated of a metallic material, and is preferably molded into disposition by insertion into the polymeric material of the fitting element 120 during or immediately after the molding thereof, and prior to the secondary molding of the gasket 122. The retaining element 48 may include a circumferentially outward flange 48A to embed within and be secured by the polymeric material of the fitting element 120, and a circumferentially inward flange 48B to project radially inwardly beyond the interior wall surface 132A of the stub wall 132 into the passageway 130 in the direction toward the main body 124. In this molded disposition, the inward flange 48B encircles the passageway 130 to engage the outer circumferential surface of the inserted end of a straight pipe section 114. Any force exerted against the straight pipe section tending to withdraw the pipe section out of the sockets 126 is resisted by the impingement of the retaining element 48 into the pipe, thereby providing a supplementary means of mechanical engagement with the pipe section assisting the clamping device 118.

FIGS. 6 and 7 depict a further embodiment of the present pipe apparatus, indicated overall at 210, wherein elements of the pipe apparatus corresponding to the elements of the apparatus of FIGS. 1-4 are identified by corresponding reference numerals in the 200 series. The pipe apparatus 210 utilizes a clamping device 218 in the form of an annular collar, indicated at 250, instead of the band-type clamps 18 of the embodiments of FIGS. 1-4 and 5. In this embodiment, the fitting assembly 212 utilizes a fitting 220 having a main body 224 and a socket 226 formed essentially in cylindrical co-axial alignment with one another, i.e., without any bell-shaped enlargement of the socket relative to the main body. The main body 224 and the socket 226 are separated interiorly by a radially inwardly projecting flange-like shoulder 236. The socket portion 226 is formed at its axially outwardmost end with a recessed annular interior wall surface 232A. The fitting assembly 212 includes an annular gasket 222 having a first axial portion 242 molded in intimate sealed annular surface engagement with the recessed wall surface 232A and a second axial portion 244 projecting outwardly beyond the annular end edge of the socket portion 226. The first and second axial portions 242, 244 of the gasket 222 form a continuous cylindrical interior gasket wall surface 238, while the outer annular surface of the second axial portion 244 is enlarged relative to the first axial portion 242 and tapers narrowingly inwardly in the direction away from the socket 226. The exterior annular surface of the socket portion 226 is formed adjacent its axial end edge with a spiral screw thread 252. The collar 250 is correspondingly formed interiorly at one axial end with a correspondingly spiral screw thread 254 and the interior wall surface of the collar 250 tapers axially therefrom toward the opposite axial end of the collar 250 correspondingly to the tapering of the second axial portion 244 of the gasket 222.

In use, as depicted in FIGS. 6 and 7, a straight plastic pipe section, e.g., pipe section 214, has one end inserted fully into the socket 226 into abutment with the shoulder 236, with the annular interior wall surface 238 of the gasket 222 fully encircling the pipe section in continuous annular sealing surface engagement with the outer circumferential wall surface of the pipe. The collar 250 is placed around the outer exterior of the pipe section with the axial end having the spiral thread 252 facing the socket 226, and is then rotated to threadedly engage the corresponding thread 254 of the collar 250. Continued rotation of the collar 250 tightens the engagement of the threads 252, 254 and, in turn, results in progressive engagement of the tapered interior of the collar 250 against the tapered exterior of the second axial gasket portion 244 to axially and radially compress the gasket portion 244 against the exterior annular surface of the pipe. Thus, as in the embodiments of the FIGS. 1-4 and 5, the collar 250 serves as a clamping device which supplements and secures the sealing contact between the gasket 222 and the pipe section 214 to resist withdrawal of the pipe section from the socket portion 226 of the fitting element 220.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A tubular polymeric pipe fitting assembly adapted for sealed joinder with a tubular polymeric pipe section, the pipe fitting assembly comprising:
a. a polymeric fitting having a tubular main body portion and an annular pipe-receiving socket portion at one end of the main body portion collectively defining interiorly therethrough a passageway, and
b. a tubular elastomeric gasket having a first axial portion in intimate sealed annular surface engagement with an interior annular wall surface of the socket portion and a second axial portion integral with the first axial portion and projecting axially outwardly from the socket portion,
c. the first and second axial portions of the gasket collectively forming a continuous interior annular wall surface adapted for receiving a tubular polymeric pipe section in peripheral annular surface contact with an exterior annular surface of the pipe section,
d. the second axial portion of the gasket adapted to be exteriorly encircled by a clamping device for exerting a mechanical force for sealing the second axial portion of the gasket against the exterior annular surface of the pipe section.

2. A tubular polymeric pipe fitting assembly according to claim 1, wherein the first axial portion of the gasket is molded in intimate sealed annular surface engagement with the interior annular wall surface of the socket portion.

3. A tubular polymeric pipe fitting assembly according to claim 2, further comprising a mechanical interconnection between the first axial portion of the gasket and the socket portion of the fitting.

4. A tubular polymeric pipe fitting assembly according to claim 3, wherein the mechanical interconnection comprises a surface depression formed into the interior annular wall surface of the socket portion into which the first axial portion of the gasket is molded.

5. A tubular polymeric pipe fitting assembly according to claim 3, wherein the mechanical interconnection comprises a radial opening formed into the interior annular wall surface of the socket portion and a stub portion protruding from the first axial portion of the gasket into the radial opening.

6. A tubular polymeric pipe fitting assembly according to claim 1, wherein the clamping device is a band clamp.

7. A tubular polymeric pipe fitting assembly according to claim 1, wherein the clamping device is an annular collar attachable to the socket portion of the fitting in compressive engagement annularly with the second axial portion of the gasket.

8. A tubular polymeric pipe fitting assembly according to claim 7, wherein the socket portion of the fitting comprises an exterior annular wall surface having a spiral thread formed therein and the annular collar comprises a mating spiral thread for rotational threaded engagement between the socket portion of the fitting and the collar.

9. A tubular polymeric pipe fitting assembly according to claim 7, wherein the collar and the second axial portion of the gasket are compatibly configured for axial and radial compression of the second axial portion of the gasket by the collar.

10. A tubular polymeric pipe fitting assembly according to claim 9, wherein the collar and the second axial portion of the gasket have mating tapered surfaces disposed for engagement with one another.

11. A tubular polymeric pipe fitting assembly according to claim 1, wherein the fitting is formed of a polymeric material selected from the group consisting of polypropylenes, polyethylenes, acrylonitrile-butadiene-styrenes, other styrenes, chlorinate poly vinyl chlorides, and other poly vinyl chlorides.

12. A tubular polymeric pipe fitting assembly according to claim 1, wherein the gasket is formed of at least one elastomer selected from the group consisting of thermoplastic vulcanizates, flexible poly vinyl chlorides, thermoplastic olefins, thermoplastic elastomers, synthetic rubbers, and natural rubbers.

13. A tubular polymeric pipe fitting assembly according to claim 1, wherein the gasket is formed of a first elastomer for promoting adhesion between the first axial portion of the gasket and the interior annular wall surface of the socket portion and a second elastomer for promoting sealing contact between the gasket and the exterior annular surface of the pipe section.

14. A tubular polymeric pipe fitting assembly according to claim 1, further comprising a retaining element disposed interiorly within the socket portion projecting radially inwardly beyond the first axial portion of the gasket for mechanical engagement with the exterior annular surface of the pipe section.

15. A tubular polymeric pipe fitting assembly according to claim 1, wherein the passageway through the tubular main body portion of the fitting is of a nominal internal cross-sectional dimension and the passageway through the annular socket portion is of an internal cross-sectional dimension greater than the nominal internal cross-sectional dimension of the passageway.

16. A tubular polymeric pipe fitting assembly according to claim 1, wherein the fitting further includes a retaining element projecting interiorly within the fitting radially inwardly into the passageway to engage the outer circumferential surface of the inserted end of a straight pipe section, thereby providing a supplementary means of mechanical engagement with the pipe section assisting the clamping device.

17. A sealed tubular polymeric pipe apparatus comprising:
a. a polymeric fitting assembly, comprising:
i. a polymeric fitting having a tubular main body portion and an annular socket portion at one end of the main body portion collectively defining interiorly therethrough a first passageway section, and
ii. a tubular elastomeric gasket having a first axial portion in intimate sealed annular surface engagement with an interior annular wall surface of the socket portion and a second axial portion integral with the first axial portion and projecting axially outwardly from the socket portion, the first and second axial portions of the gasket collectively forming a continuous interior annular wall surface,
b. a tubular polymeric pipe section received interiorly within the gasket with the interior annular wall surface of the gasket in peripheral annular surface contact with an exterior annular surface of the pipe section, the pipe section interiorly defining a second passageway section in fluid communication with the first passageway section of the fitting, and
c. a clamping device exteriorly encircling the second axial portion of the gasket for exerting a mechanical force sealing the second axial portion of the gasket against the exterior annular surface of the pipe section.

18. A sealed tubular polymeric pipe apparatus according to claim 17, wherein the first axial portion of the gasket is molded in intimate sealed annular surface engagement with the interior annular wall surface of the socket portion.

19. A sealed tubular polymeric pipe apparatus according to claim 18, further comprising a mechanical interconnection between the first axial portion of the gasket and the socket portion of the fitting.

20. A sealed tubular polymeric pipe apparatus according to claim 19, wherein the mechanical interconnection comprises a surface depression formed into the interior annular wall surface of the socket portion into which the first axial portion of the gasket is molded.

21. A sealed tubular polymeric pipe apparatus according to claim 19, wherein the mechanical interconnection comprises a radial opening formed into the interior annular wall surface of the socket portion and a stub portion protruding from the first axial portion of the gasket into the radial opening.

22. A sealed tubular polymeric pipe apparatus according to claim 17, wherein the clamping device is a band clamp.

23. A sealed tubular polymeric pipe apparatus according to claim 17, wherein the clamping device is an annular collar attached to the socket portion of the fitting in compressive engagement annularly with the second axial portion of the gasket.

24. A sealed tubular polymeric pipe apparatus according to claim 23, wherein the socket portion of the fitting comprises an exterior annular wall surface having a spiral thread formed therein and the annular collar comprises a mating spiral thread in rotational threaded engagement with one another.

25. A sealed tubular polymeric pipe apparatus according to claim 23, wherein the collar and the second axial portion of the gasket are compatibly configured for axial and radial compression of the second axial portion of the gasket by the collar.

26. A sealed tubular polymeric pipe apparatus according to claim 25, wherein the collar and the second axial portion of the gasket have mating tapered surfaces disposed in engagement with one another.

27. A sealed tubular polymeric pipe apparatus according to claim 17, wherein the fitting is formed of a polymeric material selected from the group consisting of polypropylenes, polyethylenes, acrylonitrile-butadiene-styrenes, other styrenes, chlorinate poly vinyl chlorides, and other poly vinyl chlorides.

28. A sealed tubular polymeric pipe apparatus according to claim 17, wherein the gasket is formed of at least one elastomer selected from the group consisting of thermoplastic vulcanizates, flexible poly vinyl chlorides, thermoplastic olefins, thermoplastic elastomers, synthetic rubbers, and natural rubbers.

29. A sealed tubular polymeric pipe apparatus according to claim 17, wherein the gasket is formed of a first elastomer promoting adhesion between the first axial portion of the gasket and the interior annular wall surface of the socket portion and a second elastomer promoting sealing contact between the gasket and the exterior annular surface of the pipe section.

30. A sealed tubular polymeric pipe apparatus according to claim 17, further comprising a retaining element disposed interiorly within the socket portion projecting radially inwardly beyond the first axial portion of the gasket for mechanical engagement with the exterior annular surface of the pipe section.

31. A sealed tubular polymeric pipe assembly according to claim 17, wherein the first passageway section through the tubular main body portion of the fitting is of a nominal internal cross-sectional dimension and the first passageway section through the annular socket portion is of an internal cross-sectional dimension greater than the nominal internal cross-sectional dimension of the passageway.

32. A sealed tubular polymeric pipe assembly according to claim 17, wherein the fitting further includes a retaining element projecting interiorly within the fitting radially inwardly into the passageway to engage the outer circumferential surface of the inserted end of a straight pipe section, thereby providing a supplementary means of mechanical engagement with the pipe section assisting the clamping device.
